(19) United States
(12) Patent Application Publication
(10) Pub. No.: US 2025/0260249 A1
(43) Pub. Date: Aug. 14, 2025

(54) PORTABLE CHARGER WITHOUT A BATTERY FOR WEARABLE DEVICES

(71) Applicant: Oura Health Oy, Oulu (FI)

(72) Inventor: Antti Pekka Saikkonen, Oulu (FI)

(21) Appl. No.: 18/441,385

(22) Filed: Feb. 14, 2024

(51) Int. Cl. H02J 7/00

(52) U.S. Cl. CPC H02J 7/0044

(57) ABSTRACT

Methods, systems, and devices for charging a wearable device are described. According to the techniques described herein, a portable charger for a wearable ring device may be configured to charge the wearable device in multiple charging orientations. The portable charger may include a plug component that can connect to external power sources. The portable charger may operate in multiple orientations. For example, the portable charger may have a retaining component that can be oriented opposite to the plug component in a “travel” orientation such that the wearable ring device may be secured onto the portable charger while the portable charger is connected to the external power source. The retaining component may be oriented on a same side as the plug component in a “home” orientation such that the user may remove the wearable ring device from the portable charger while the portable charger is connected to the external power source.

### FIELD OF TECHNOLOGY

The following relates to wearable devices and data processing, including a portable charger without a battery for wearable devices.

### BACKGROUND

Some wearable devices may be configured to collect data from users and may use a rechargeable battery to power one or more sensors associated with collecting the data. In some examples, the user may want to charge the rechargeable battery without using a bulky charging device (e.g., when the user is traveling).

### BRIEF DESCRIPTION OF THE DRAWINGS

FIG. 1 illustrates an example of a system that supports a portable charger without a battery for wearable devices in accordance with aspects of the present disclosure.

FIG. 2 illustrates an example of a system that supports a portable charger without a battery for wearable devices in accordance with aspects of the present disclosure.

FIG. 3 shows an example of a system that supports a portable charger without a battery for wearable devices in accordance with aspects of the present disclosure.

FIGS. 4A and 4B show examples of charging diagrams that support a portable charger without a battery for wearable devices in accordance with aspects of the present disclosure.

FIGS. 5A and 5B show examples of charging diagrams that support a portable charger without a battery for wearable devices in accordance with aspects of the present disclosure.

FIGS. 6A and 6B show examples of charging diagrams that support a portable charger without a battery for wearable devices in accordance with aspects of the present disclosure.

### DETAILED DESCRIPTION

Some users of wearable ring devices may use a portable or travel charger to charge the wearable ring devices. In some examples, the travel chargers may include a charger post with one or more inductive charging components and a battery that may power the inductive charging components. However, portable chargers including such batteries may be costly to manufacture, may be bulky, and may have a low charging efficiency (e.g., below 50%), which may decrease user experience. Additionally, the wearable ring device may not be secure on the charger post, and may easily fall off while transporting, which may also decrease user experience.

Accordingly, as described herein, a portable charger device for a wearable ring device may not include a battery component and may be configured to charge a wireless device in multiple charging orientations. The portable charger device may include a plug component (e.g., a Universal Serial Bus (USB) Type-C (USB-C) plug) that can connect to external power sources (e.g., a third party device such as a computer, phone, portable battery, or a USB-C wall outlet adapter). The portable charger device may operate in multiple orientations, including a “home” orientation and a “travel” orientation. For example, the portable charger device may have a retaining component that can be oriented opposite to the plug component in the “travel” orientation such that the wearable ring device may be secured onto the portable charger device while the portable charger device is connected to the external power source. The retaining component may be oriented on a same side as the plug component in the “home” orientation such that the user may easily remove the wearable ring device from the portable charger device while the portable charger device is connected to the external power source.

In some examples, the plug component may be hinged such that the user may “flip” the portable charger device from the travel orientation to the home orientation. In such examples, the size of the portable charger device may be specific to a wearable ring device size. In some examples, the portable charger device may include a separate component (e.g., a size adapter component) that can be connected to the plug component in either the home or travel orientation. That is, the size adapter component may include the retaining component, and may be “snapped” into place on the plug component with the retaining component either on the same side as or on the opposite side from the plug component. In such examples, the plug component may be common across wearable ring device sizes, and the size adapter component may be specific to a wearable ring device size.

Aspects of the disclosure are initially described in the context of systems supporting physiological data collection from users via wearable devices. Aspects of the disclosure are further illustrated by and described with reference to charger diagrams that relate to a portable charger without a battery for wearable devices.

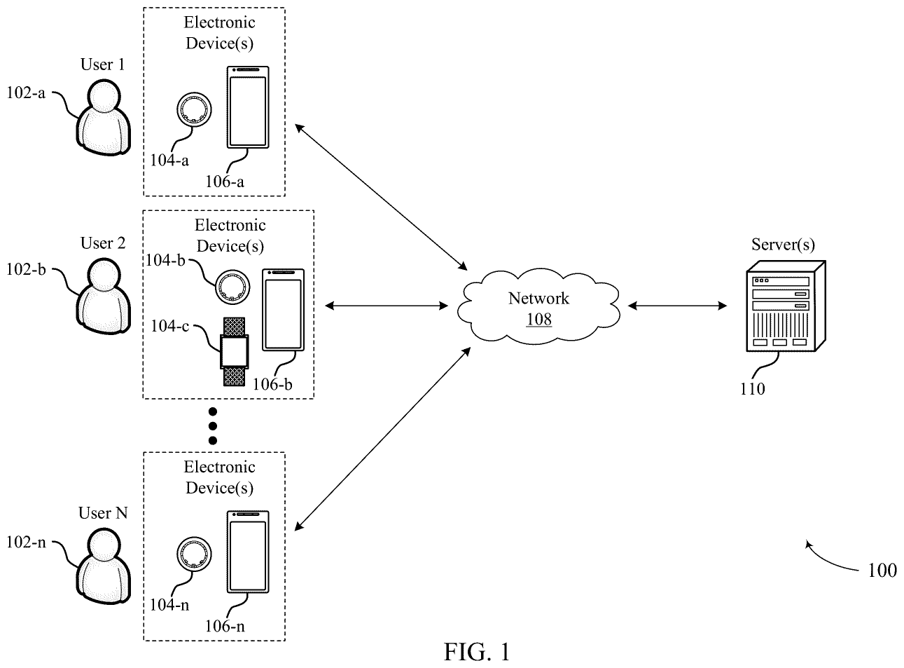

FIG. 1 illustrates an example of a system 100 that supports a portable charger without a battery for wearable devices in accordance with aspects of the present disclosure. The system 100 includes a plurality of electronic devices (e.g., wearable devices 104, user devices 106) that may be worn and/or operated by one or more users 102. The system 100 further includes a network 108 and one or more servers 110.

The electronic devices may include any electronic devices known in the art, including wearable devices 104 (e.g., ring wearable devices, watch wearable devices, etc.), user devices 106 (e.g., smartphones, laptops, tablets). The electronic devices associated with the respective users 102 may include one or more of the following functionalities: 1) measuring physiological data, 2) storing the measured data, 3) processing the data, 4) providing outputs (e.g., via GUIs) to a user 102 based on the processed data, and 5) communicating data with one another and/or other computing devices. Different electronic devices may perform one or more of the functionalities.

Example wearable devices 104 may include wearable computing devices, such as a ring computing device (hereinafter “ring”) configured to be worn on a user's 102 finger, a wrist computing device (e.g., a smart watch, fitness band, or bracelet) configured to be worn on a user's 102 wrist, and/or a head mounted computing device (e.g., glasses/goggles). Wearable devices 104 may also include bands, straps (e.g., flexible or inflexible bands or straps), stick-on sensors, and the like, that may be positioned in other locations, such as bands around the head (e.g., a forehead headband), arm (e.g., a forearm band and/or bicep band), and/or leg (e.g., a thigh or calf band), behind the ear, under the armpit, and the like. Wearable devices 104 may also be attached to, or included in, articles of clothing. For example, wearable devices 104 may be included in pockets and/or pouches on clothing. As another example, wearable device 104 may be clipped and/or pinned to clothing, or may otherwise be maintained within the vicinity of the user 102. Example articles of clothing may include, but are not limited to, hats, shirts, gloves, pants, socks, outerwear (e.g., jackets), and undergarments. In some implementations, wearable devices 104 may be included with other types of devices such as training/sporting devices that are used during physical activity. For example, wearable devices 104 may be attached to, or included in, a bicycle, skis, a tennis racket, a golf club, and/or training weights.

Much of the present disclosure may be described in the context of a ring wearable device 104. Accordingly, the terms “ring 104,” “wearable device 104,” and like terms, may be used interchangeably, unless noted otherwise herein. However, the use of the term “ring 104” is not to be regarded as limiting, as it is contemplated herein that aspects of the present disclosure may be performed using other wearable devices (e.g., watch wearable devices, necklace wearable device, bracelet wearable devices, earring wearable devices, anklet wearable devices, and the like).

In some aspects, user devices 106 may include handheld mobile computing devices, such as smartphones and tablet computing devices. User devices 106 may also include personal computers, such as laptop and desktop computing devices. Other example user devices 106 may include server computing devices that may communicate with other electronic devices (e.g., via the Internet). In some implementations, computing devices may include medical devices, such as external wearable computing devices (e.g., Holter monitors). Medical devices may also include implantable medical devices, such as pacemakers and cardioverter defibrillators. Other example user devices 106 may include home computing devices, such as internet of things (IoT) devices (e.g., IoT devices), smart televisions, smart speakers, smart displays (e.g., video call displays), hubs (e.g., wireless communication hubs), security systems, smart appliances (e.g., thermostats and refrigerators), and fitness equipment.

Some electronic devices (e.g., wearable devices 104, user devices 106) may measure physiological parameters of respective users 102, such as photoplethysmography waveforms, continuous skin temperature, a pulse waveform, respiration rate, heart rate, heart rate variability (HRV), actigraphy, galvanic skin response, pulse oximetry, blood oxygen saturation (SpO2), blood sugar levels (e.g., glucose metrics), and/or other physiological parameters. Some electronic devices that measure physiological parameters may also perform some/all of the calculations described herein. Some electronic devices may not measure physiological parameters, but may perform some/all of the calculations described herein. For example, a ring (e.g., wearable device 104), mobile device application, or a server computing device may process received physiological data that was measured by other devices.

In some implementations, a user 102 may operate, or may be associated with, multiple electronic devices, some of which may measure physiological parameters and some of which may process the measured physiological parameters. In some implementations, a user 102 may have a ring (e.g., wearable device 104) that measures physiological parameters. The user 102 may also have, or be associated with, a user device 106 (e.g., mobile device, smartphone), where the wearable device 104 and the user device 106 are communicatively coupled to one another. In some cases, the user device 106 may receive data from the wearable device 104 and perform some/all of the calculations described herein. In some implementations, the user device 106 may also measure physiological parameters described herein, such as motion/activity parameters.

For example, as illustrated in FIG. 1, a first user 102-a (User 1) may operate, or may be associated with, a wearable device 104-a (e.g., ring 104-a) and a user device 106-a that may operate as described herein. In this example, the user device 106-a associated with user 102-a may process/store physiological parameters measured by the ring 104-a. Comparatively, a second user 102-b (User 2) may be associated with a ring 104-b, a watch wearable device 104-c (e.g., watch 104-c), and a user device 106-b, where the user device 106-b associated with user 102-b may process/store physiological parameters measured by the ring 104-b and/or the watch 104-c. Moreover, an nth user 102-n (User N) may be associated with an arrangement of electronic devices described herein (e.g., ring 104-n, user device 106-n). In some aspects, wearable devices 104 (e.g., rings 104, watches 104) and other electronic devices may be communicatively coupled to the user devices 106 of the respective users 102 via Bluetooth, Wi-Fi, and other wireless protocols. Moreover, in some cases, the wearable device 104 and the user device 106 may be included within (or make up) the same device. For example, in some cases, the wearable device 104 may be configured to execute an application associated with the wearable device 104, and may be configured to display data via a GUI.

In some implementations, the rings 104 (e.g., wearable devices 104) of the system 100 may be configured to collect physiological data from the respective users 102 based on arterial blood flow within the user's finger. In particular, a ring 104 may utilize one or more light-emitting components, such as LEDs (e.g., red LEDs, green LEDs) that emit light on the palm-side of a user's finger to collect physiological data based on arterial blood flow within the user's finger. In general, the terms light-emitting components, light-emitting elements, and like terms, may include, but are not limited to, LEDs, micro LEDs, mini LEDs, laser diodes (LDs) (e.g., vertical cavity surface-emitting lasers (VCSELs), and the like.

In some cases, the system 100 may be configured to collect physiological data from the respective users 102 based on blood flow diffused into a microvascular bed of skin with capillaries and arterioles. For example, the system 100 may collect PPG data based on a measured amount of blood diffused into the microvascular system of capillaries and arterioles. In some implementations, the ring 104 may acquire the physiological data using a combination of both green and red LEDs. The physiological data may include any physiological data known in the art including, but not limited to, temperature data, accelerometer data (e.g., movement/motion data), heart rate data, HRV data, blood oxygen level data, or any combination thereof.

The use of both green and red LEDs may provide several advantages over other solutions, as red and green LEDs have been found to have their own distinct advantages when acquiring physiological data under different conditions (e.g., light/dark, active/inactive) and via different parts of the body, and the like. For example, green LEDs have been found to exhibit better performance during exercise. Moreover, using multiple LEDs (e.g., green and red LEDs) distributed around the ring 104 has been found to exhibit superior performance as compared to wearable devices that utilize LEDs that are positioned close to one another, such as within a watch wearable device. Furthermore, the blood vessels in the finger (e.g., arteries, capillaries) are more accessible via LEDs as compared to blood vessels in the wrist. In particular, arteries in the wrist are positioned on the bottom of the wrist (e.g., palm-side of the wrist), meaning only capillaries are accessible on the top of the wrist (e.g., back of hand side of the wrist), where wearable watch devices and similar devices are typically worn. As such, utilizing LEDs and other sensors within a ring 104 has been found to exhibit superior performance as compared to wearable devices worn on the wrist, as the ring 104 may have greater access to arteries (as compared to capillaries), thereby resulting in stronger signals and more valuable physiological data.

The electronic devices of the system 100 (e.g., user devices 106, wearable devices 104) may be communicatively coupled to one or more servers 110 via wired or wireless communication protocols. For example, as shown in FIG. 1, the electronic devices (e.g., user devices 106) may be communicatively coupled to one or more servers 110 via a network 108. The network 108 may implement transfer control protocol and internet protocol (TCP/IP), such as the Internet, or may implement other network 108 protocols. Network connections between the network 108 and the respective electronic devices may facilitate transport of data via email, web, text messages, mail, or any other appropriate form of interaction within a computer network 108. For example, in some implementations, the ring 104-a associated with the first user 102-a may be communicatively coupled to the user device 106-a, where the user device 106-a is communicatively coupled to the servers 110 via the network 108. In additional or alternative cases, wearable devices 104 (e.g., rings 104, watches 104) may be directly communicatively coupled to the network 108.

The system 100 may offer an on-demand database service between the user devices 106 and the one or more servers 110. In some cases, the servers 110 may receive data from the user devices 106 via the network 108, and may store and analyze the data. Similarly, the servers 110 may provide data to the user devices 106 via the network 108. In some cases, the servers 110 may be located at one or more data centers. The servers 110 may be used for data storage, management, and processing. In some implementations, the servers 110 may provide a web-based interface to the user device 106 via web browsers.

In some aspects, the system 100 may detect periods of time that a user 102 is asleep, and classify periods of time that the user 102 is asleep into one or more sleep stages (e.g., sleep stage classification). For example, as shown in FIG. 1, User 102-a may be associated with a wearable device 104-a (e.g., ring 104-a) and a user device 106-a. In this example, the ring 104-a may collect physiological data associated with the user 102-a, including temperature, heart rate, HRV, respiratory rate, and the like. In some aspects, data collected by the ring 104-a may be input to a machine learning classifier, where the machine learning classifier is configured to determine periods of time that the user 102-a is (or was) asleep. Moreover, the machine learning classifier may be configured to classify periods of time into different sleep stages, including an awake sleep stage, a rapid eye movement (REM) sleep stage, a light sleep stage (non-REM (NREM)), and a deep sleep stage (NREM). In some aspects, the classified sleep stages may be displayed to the user 102-a via a GUI of the user device 106-a. Sleep stage classification may be used to provide feedback to a user 102-a regarding the user's sleeping patterns, such as recommended bedtimes, recommended wake-up times, and the like. Moreover, in some implementations, sleep stage classification techniques described herein may be used to calculate scores for the respective user, such as Sleep Scores, Readiness Scores, and the like.

In some aspects, the system 100 may utilize circadian rhythm-derived features to further improve physiological data collection, data processing procedures, and other techniques described herein. The term circadian rhythm may refer to a natural, internal process that regulates an individual's sleep-wake cycle, that repeats approximately every 24 hours. In this regard, techniques described herein may utilize circadian rhythm adjustment models to improve physiological data collection, analysis, and data processing. For example, a circadian rhythm adjustment model may be input into a machine learning classifier along with physiological data collected from the user 102-a via the wearable device 104-a. In this example, the circadian rhythm adjustment model may be configured to “weight,” or adjust, physiological data collected throughout a user's natural, approximately 24-hour circadian rhythm. In some implementations, the system may initially start with a “baseline” circadian rhythm adjustment model, and may modify the baseline model using physiological data collected from each user 102 to generate tailored, individualized circadian rhythm adjustment models that are specific to each respective user 102.

In some aspects, the system 100 may utilize other biological rhythms to further improve physiological data collection, analysis, and processing by phase of these other rhythms. For example, if a weekly rhythm is detected within an individual's baseline data, then the model may be configured to adjust “weights” of data by day of the week. Biological rhythms that may require adjustment to the model by this method include: 1) ultradian (faster than a day rhythms, including sleep cycles in a sleep state, and oscillations from less than an hour to several hours periodicity in the measured physiological variables during wake state; 2) circadian rhythms; 3) non-endogenous daily rhythms shown to be imposed on top of circadian rhythms, as in work schedules; 4) weekly rhythms, or other artificial time periodicities exogenously imposed (e.g., in a hypothetical culture with 12 day “weeks,” 12 day rhythms could be used); 5) multi-day ovarian rhythms in women and spermatogenesis rhythms in men; 6) lunar rhythms (relevant for individuals living with low or no artificial lights); and 7) seasonal rhythms.

The biological rhythms are not always stationary rhythms. For example, many women experience variability in ovarian cycle length across cycles, and ultradian rhythms are not expected to occur at exactly the same time or periodicity across days even within a user. As such, signal processing techniques sufficient to quantify the frequency composition while preserving temporal resolution of these rhythms in physiological data may be used to improve detection of these rhythms, to assign phase of each rhythm to each moment in time measured, and to thereby modify adjustment models and comparisons of time intervals. The biological rhythm-adjustment models and parameters can be added in linear or non-linear combinations as appropriate to more accurately capture the dynamic physiological baselines of an individual or group of individuals.

In some aspects, the respective devices of the system 100 may support techniques for a charging device (e.g., a portable charger for a wearable device 104) without a battery. For example, the charging device may include one or more portions that may be reconfigured into a first charging orientation and a second charging orientation. In the first charging orientation, the charging device may include a flange that may be on a same side of a charger post as a power receiving component (e.g., such that the wearable device 104 may be easily removed from the charger base). In the second charging orientation, the charging device may include the flange that may be on a different (e.g., opposite) side of the charger post as the power receiving component (e.g., such that the wearable device 104 may not be easily removed from the charger base when the power receiving component is coupled to an external power source).

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

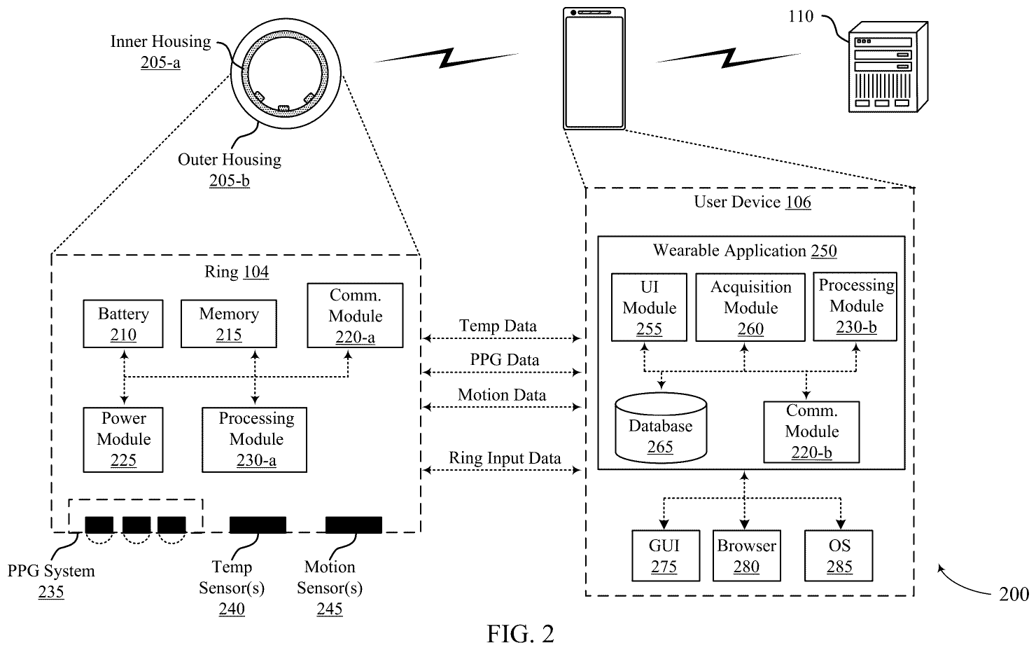

FIG. 2 illustrates an example of a system 200 that supports a portable charger without a battery for wearable devices in accordance with aspects of the present disclosure. The system 200 may implement, or be implemented by, system 100. In particular, system 200 illustrates an example of a ring 104 (e.g., wearable device 104), a user device 106, and a server 110, as described with reference to FIG. 1.

In some aspects, the ring 104 may be configured to be worn around a user's finger, and may determine one or more user physiological parameters when worn around the user's finger. Example measurements and determinations may include, but are not limited to, user skin temperature, pulse waveforms, respiratory rate, heart rate, HRV, blood oxygen levels (SpO2), blood sugar levels (e.g., glucose metrics), and the like.

The system 200 further includes a user device 106 (e.g., a smartphone) in communication with the ring 104. For example, the ring 104 may be in wireless and/or wired communication with the user device 106. In some implementations, the ring 104 may send measured and processed data (e.g., temperature data, photoplethysmogram (PPG) data, motion/accelerometer data, ring input data, and the like) to the user device 106. The user device 106 may also send data to the ring 104, such as ring 104 firmware/configuration updates. The user device 106 may process data. In some implementations, the user device 106 may transmit data to the server 110 for processing and/or storage.

The ring 104 may include a housing 205 that may include an inner housing 205-a and an outer housing 205-b. In some aspects, the housing 205 of the ring 104 may store or otherwise include various components of the ring including, but not limited to, device electronics, a power source (e.g., battery 210, and/or capacitor), one or more substrates (e.g., printable circuit boards) that interconnect the device electronics and/or power source, and the like. The device electronics may include device modules (e.g., hardware/software), such as: a processing module 230-a, a memory 215, a communication module 220-a, a power module 225, and the like. The device electronics may also include one or more sensors. Example sensors may include one or more temperature sensors 240, a PPG sensor assembly (e.g., PPG system 235), and one or more motion sensors 245.

The sensors may include associated modules (not illustrated) configured to communicate with the respective components/modules of the ring 104, and generate signals associated with the respective sensors. In some aspects, each of the components/modules of the ring 104 may be communicatively coupled to one another via wired or wireless connections. Moreover, the ring 104 may include additional and/or alternative sensors or other components that are configured to collect physiological data from the user, including light sensors (e.g., LEDs), oximeters, and the like.

The ring 104 shown and described with reference to FIG. 2 is provided solely for illustrative purposes. As such, the ring 104 may include additional or alternative components as those illustrated in FIG. 2. Other rings 104 that provide functionality described herein may be fabricated. For example, rings 104 with fewer components (e.g., sensors) may be fabricated. In a specific example, a ring 104 with a single temperature sensor 240 (or other sensor), a power source, and device electronics configured to read the single temperature sensor 240 (or other sensor) may be fabricated. In another specific example, a temperature sensor 240 (or other sensor) may be attached to a user's finger (e.g., using adhesives, wraps, clamps, spring loaded clamps, etc.). In this case, the sensor may be wired to another computing device, such as a wrist worn computing device that reads the temperature sensor 240 (or other sensor). In other examples, a ring 104 that includes additional sensors and processing functionality may be fabricated.

The housing 205 may include one or more housing 205 components. The housing 205 may include an outer housing 205-b component (e.g., a shell) and an inner housing 205-a component (e.g., a molding). The housing 205 may include additional components (e.g., additional layers) not explicitly illustrated in FIG. 2. For example, in some implementations, the ring 104 may include one or more insulating layers that electrically insulate the device electronics and other conductive materials (e.g., electrical traces) from the outer housing 205-b (e.g., a metal outer housing 205-b). The housing 205 may provide structural support for the device electronics, battery 210, substrate(s), and other components. For example, the housing 205 may protect the device electronics, battery 210, and substrate(s) from mechanical forces, such as pressure and impacts. The housing 205 may also protect the device electronics, battery 210, and substrate(s) from water and/or other chemicals.

The outer housing 205-b may be fabricated from one or more materials. In some implementations, the outer housing 205-b may include a metal, such as titanium, that may provide strength and abrasion resistance at a relatively light weight. The outer housing 205-b may also be fabricated from other materials, such polymers. In some implementations, the outer housing 205-b may be protective as well as decorative.

The inner housing 205-a may be configured to interface with the user's finger. The inner housing 205-a may be formed from a polymer (e.g., a medical grade polymer) or other material. In some implementations, the inner housing 205-a may be transparent. For example, the inner housing 205-a may be transparent to light emitted by the PPG light emitting diodes (LEDs). In some implementations, the inner housing 205-a component may be molded onto the outer housing 205-b. For example, the inner housing 205-a may include a polymer that is molded (e.g., injection molded) to fit into an outer housing 205-b metallic shell.

The ring 104 may include one or more substrates (not illustrated). The device electronics and battery 210 may be included on the one or more substrates. For example, the device electronics and battery 210 may be mounted on one or more substrates. Example substrates may include one or more printed circuit boards (PCBs), such as flexible PCB (e.g., polyimide). In some implementations, the electronics/battery 210 may include surface mounted devices (e.g., surface-mount technology (SMT) devices) on a flexible PCB. In some implementations, the one or more substrates (e.g., one or more flexible PCBs) may include electrical traces that provide electrical communication between device electronics. The electrical traces may also connect the battery 210 to the device electronics.

The device electronics, battery 210, and substrates may be arranged in the ring 104 in a variety of ways. In some implementations, one substrate that includes device electronics may be mounted along the bottom of the ring 104 (e.g., the bottom half), such that the sensors (e.g., PPG system 235, temperature sensors 240, motion sensors 245, and other sensors) interface with the underside of the user's finger. In these implementations, the battery 210 may be included along the top portion of the ring 104 (e.g., on another substrate).

The various components/modules of the ring 104 represent functionality (e.g., circuits and other components) that may be included in the ring 104. Modules may include any discrete and/or integrated electronic circuit components that implement analog and/or digital circuits capable of producing the functions attributed to the modules herein. For example, the modules may include analog circuits (e.g., amplification circuits, filtering circuits, analog/digital conversion circuits, and/or other signal conditioning circuits). The modules may also include digital circuits (e.g., combinational or sequential logic circuits, memory circuits etc.).

The memory 215 (memory module) of the ring 104 may include any volatile, non-volatile, magnetic, or electrical media, such as a random access memory (RAM), read-only memory (ROM), non-volatile RAM (NVRAM), electrically-erasable programmable ROM (EEPROM), flash memory, or any other memory device. The memory 215 may store any of the data described herein. For example, the memory 215 may be configured to store data (e.g., motion data, temperature data, PPG data) collected by the respective sensors and PPG system 235. Furthermore, memory 215 may include instructions that, when executed by one or more processing circuits, cause the modules to perform various functions attributed to the modules herein. The device electronics of the ring 104 described herein are only example device electronics. As such, the types of electronic components used to implement the device electronics may vary based on design considerations.

The functions attributed to the modules of the ring 104 described herein may be embodied as one or more processors, hardware, firmware, software, or any combination thereof. Depiction of different features as modules is intended to highlight different functional aspects and does not necessarily imply that such modules must be realized by separate hardware/software components. Rather, functionality associated with one or more modules may be performed by separate hardware/software components or integrated within common hardware/software components.

The processing module 230-a of the ring 104 may include one or more processors (e.g., processing units), microcontrollers, digital signal processors, systems on a chip (SOCs), and/or other processing devices. The processing module 230-a communicates with the modules included in the ring 104. For example, the processing module 230-a may transmit/receive data to/from the modules and other components of the ring 104, such as the sensors. As described herein, the modules may be implemented by various circuit components. Accordingly, the modules may also be referred to as circuits (e.g., a communication circuit and power circuit).

The processing module 230-a may communicate with the memory 215. The memory 215 may include computer-readable instructions that, when executed by the processing module 230-a, cause the processing module 230-a to perform the various functions attributed to the processing module 230-a herein. In some implementations, the processing module 230-a (e.g., a microcontroller) may include additional features associated with other modules, such as communication functionality provided by the communication module 220-a (e.g., an integrated Bluetooth Low Energy transceiver) and/or additional onboard memory 215.

The communication module 220-a may include circuits that provide wireless and/or wired communication with the user device 106 (e.g., communication module 220-b of the user device 106). In some implementations, the communication modules 220-a, 220-b may include wireless communication circuits, such as Bluetooth circuits and/or Wi-Fi circuits. In some implementations, the communication modules 220-a, 220-b can include wired communication circuits, such as USB communication circuits. Using the communication module 220-a, the ring 104 and the user device 106 may be configured to communicate with each other. The processing module 230-a of the ring may be configured to transmit/receive data to/from the user device 106 via the communication module 220-a. Example data may include, but is not limited to, motion data, temperature data, pulse waveforms, heart rate data, HRV data, PPG data, and status updates (e.g., charging status, battery charge level, and/or ring 104 configuration settings). The processing module 230-a of the ring may also be configured to receive updates (e.g., software/firmware updates) and data from the user device 106.

The ring 104 may include a battery 210 (e.g., a rechargeable battery 210). An example battery 210 may include a Lithium-Ion or Lithium-Polymer type battery 210, although a variety of battery 210 options are possible. The battery 210 may be wirelessly charged. In some implementations, the ring 104 may include a power source other than the battery 210, such as a capacitor. The power source (e.g., battery 210 or capacitor) may have a curved geometry that matches the curve of the ring 104. In some aspects, a charger or other power source may include additional sensors that may be used to collect data in addition to, or that supplements, data collected by the ring 104 itself. Moreover, a charger or other power source for the ring 104 may function as a user device 106, in which case the charger or other power source for the ring 104 may be configured to receive data from the ring 104, store and/or process data received from the ring 104, and communicate data between the ring 104 and the servers 110.

In some aspects, the ring 104 includes a power module 225 that may control charging of the battery 210. For example, the power module 225 may interface with an external wireless charger that charges the battery 210 when interfaced with the ring 104. The charger may include a datum structure that mates with a ring 104 datum structure to create a specified orientation with the ring 104 during charging. The power module 225 may also regulate voltage(s) of the device electronics, regulate power output to the device electronics, and monitor the state of charge of the battery 210. In some implementations, the battery 210 may include a protection circuit module (PCM) that protects the battery 210 from high current discharge, over voltage during charging, and under voltage during discharge. The power module 225 may also include electro-static discharge (ESD) protection.

The one or more temperature sensors 240 may be electrically coupled to the processing module 230-a. The temperature sensor 240 may be configured to generate a temperature signal (e.g., temperature data) that indicates a temperature read or sensed by the temperature sensor 240. The processing module 230-a may determine a temperature of the user in the location of the temperature sensor 240. For example, in the ring 104, temperature data generated by the temperature sensor 240 may indicate a temperature of a user at the user's finger (e.g., skin temperature). In some implementations, the temperature sensor 240 may contact the user's skin. In other implementations, a portion of the housing 205 (e.g., the inner housing 205-a) may form a barrier (e.g., a thin, thermally conductive barrier) between the temperature sensor 240 and the user's skin. In some implementations, portions of the ring 104 configured to contact the user's finger may have thermally conductive portions and thermally insulative portions. The thermally conductive portions may conduct heat from the user's finger to the temperature sensors 240. The thermally insulative portions may insulate portions of the ring 104 (e.g., the temperature sensor 240) from ambient temperature.

In some implementations, the temperature sensor 240 may generate a digital signal (e.g., temperature data) that the processing module 230-a may use to determine the temperature. As another example, in cases where the temperature sensor 240 includes a passive sensor, the processing module 230-a (or a temperature sensor 240 module) may measure a current/voltage generated by the temperature sensor 240 and determine the temperature based on the measured current/voltage. Example temperature sensors 240 may include a thermistor, such as a negative temperature coefficient (NTC) thermistor, or other types of sensors including resistors, transistors, diodes, and/or other electrical/electronic components.

The processing module 230-a may sample the user's temperature over time. For example, the processing module 230-a may sample the user's temperature according to a sampling rate. An example sampling rate may include one sample per second, although the processing module 230-a may be configured to sample the temperature signal at other sampling rates that are higher or lower than one sample per second. In some implementations, the processing module 230-a may sample the user's temperature continuously throughout the day and night. Sampling at a sufficient rate (e.g., one sample per second) throughout the day may provide sufficient temperature data for analysis described herein.

The processing module 230-a may store the sampled temperature data in memory 215. In some implementations, the processing module 230-a may process the sampled temperature data. For example, the processing module 230-a may determine average temperature values over a period of time. In one example, the processing module 230-a may determine an average temperature value each minute by summing all temperature values collected over the minute and dividing by the number of samples over the minute. In a specific example where the temperature is sampled at one sample per second, the average temperature may be a sum of all sampled temperatures for one minute divided by sixty seconds. The memory 215 may store the average temperature values over time. In some implementations, the memory 215 may store average temperatures (e.g., one per minute) instead of sampled temperatures in order to conserve memory 215.

The sampling rate, which may be stored in memory 215, may be configurable. In some implementations, the sampling rate may be the same throughout the day and night. In other implementations, the sampling rate may be changed throughout the day/night. In some implementations, the ring 104 may filter/reject temperature readings, such as large spikes in temperature that are not indicative of physiological changes (e.g., a temperature spike from a hot shower). In some implementations, the ring 104 may filter/reject temperature readings that may not be reliable due to other factors, such as excessive motion during exercise (e.g., as indicated by a motion sensor 245).

The ring 104 (e.g., communication module) may transmit the sampled and/or average temperature data to the user device 106 for storage and/or further processing. The user device 106 may transfer the sampled and/or average temperature data to the server 110 for storage and/or further processing.

Although the ring 104 is illustrated as including a single temperature sensor 240, the ring 104 may include multiple temperature sensors 240 in one or more locations, such as arranged along the inner housing 205-a near the user's finger. In some implementations, the temperature sensors 240 may be stand-alone temperature sensors 240. Additionally, or alternatively, one or more temperature sensors 240 may be included with other components (e.g., packaged with other components), such as with the accelerometer and/or processor.

The processing module 230-a may acquire and process data from multiple temperature sensors 240 in a similar manner described with respect to a single temperature sensor 240. For example, the processing module 230 may individually sample, average, and store temperature data from each of the multiple temperature sensors 240. In other examples, the processing module 230-a may sample the sensors at different rates and average/store different values for the different sensors. In some implementations, the processing module 230-a may be configured to determine a single temperature based on the average of two or more temperatures determined by two or more temperature sensors 240 in different locations on the finger.

The temperature sensors 240 on the ring 104 may acquire distal temperatures at the user's finger (e.g., any finger). For example, one or more temperature sensors 240 on the ring 104 may acquire a user's temperature from the underside of a finger or at a different location on the finger. In some implementations, the ring 104 may continuously acquire distal temperature (e.g., at a sampling rate). Although distal temperature measured by a ring 104 at the finger is described herein, other devices may measure temperature at the same/different locations. In some cases, the distal temperature measured at a user's finger may differ from the temperature measured at a user's wrist or other external body location. Additionally, the distal temperature measured at a user's finger (e.g., a “shell” temperature) may differ from the user's core temperature. As such, the ring 104 may provide a useful temperature signal that may not be acquired at other internal/external locations of the body. In some cases, continuous temperature measurement at the finger may capture temperature fluctuations (e.g., small or large fluctuations) that may not be evident in core temperature. For example, continuous temperature measurement at the finger may capture minute-to-minute or hour-to-hour temperature fluctuations that provide additional insight that may not be provided by other temperature measurements elsewhere in the body.

The ring 104 may include a PPG system 235. The PPG system 235 may include one or more optical transmitters that transmit light. The PPG system 235 may also include one or more optical receivers that receive light transmitted by the one or more optical transmitters. An optical receiver may generate a signal (hereinafter “PPG” signal) that indicates an amount of light received by the optical receiver. The optical transmitters may illuminate a region of the user's finger. The PPG signal generated by the PPG system 235 may indicate the perfusion of blood in the illuminated region. For example, the PPG signal may indicate blood volume changes in the illuminated region caused by a user's pulse pressure. The processing module 230-a may sample the PPG signal and determine a user's pulse waveform based on the PPG signal. The processing module 230-a may determine a variety of physiological parameters based on the user's pulse waveform, such as a user's respiratory rate, heart rate, HRV, oxygen saturation, and other circulatory parameters.

In some implementations, the PPG system 235 may be configured as a reflective PPG system 235 where the optical receiver(s) receive transmitted light that is reflected through the region of the user's finger. In some implementations, the PPG system 235 may be configured as a transmissive PPG system 235 where the optical transmitter(s) and optical receiver(s) are arranged opposite to one another, such that light is transmitted directly through a portion of the user's finger to the optical receiver(s).

The number and ratio of transmitters and receivers included in the PPG system 235 may vary. Example optical transmitters may include light-emitting diodes (LEDs). The optical transmitters may transmit light in the infrared spectrum and/or other spectrums. Example optical receivers may include, but are not limited to, photosensors, phototransistors, and photodiodes. The optical receivers may be configured to generate PPG signals in response to the wavelengths received from the optical transmitters. The location of the transmitters and receivers may vary. Additionally, a single device may include reflective and/or transmissive PPG systems 235.

The PPG system 235 illustrated in FIG. 2 may include a reflective PPG system 235 in some implementations. In these implementations, the PPG system 235 may include a centrally located optical receiver (e.g., at the bottom of the ring 104) and two optical transmitters located on each side of the optical receiver. In this implementation, the PPG system 235 (e.g., optical receiver) may generate the PPG signal based on light received from one or both of the optical transmitters. In other implementations, other placements, combinations, and/or configurations of one or more optical transmitters and/or optical receivers are contemplated.

The processing module 230-a may control one or both of the optical transmitters to transmit light while sampling the PPG signal generated by the optical receiver. In some implementations, the processing module 230-a may cause the optical transmitter with the stronger received signal to transmit light while sampling the PPG signal generated by the optical receiver. For example, the selected optical transmitter may continuously emit light while the PPG signal is sampled at a sampling rate (e.g., 250 Hz).

Sampling the PPG signal generated by the PPG system 235 may result in a pulse waveform that may be referred to as a “PPG.” The pulse waveform may indicate blood pressure vs time for multiple cardiac cycles. The pulse waveform may include peaks that indicate cardiac cycles. Additionally, the pulse waveform may include respiratory induced variations that may be used to determine respiration rate. The processing module 230-a may store the pulse waveform in memory 215 in some implementations. The processing module 230-a may process the pulse waveform as it is generated and/or from memory 215 to determine user physiological parameters described herein.

The processing module 230-a may determine the user's heart rate based on the pulse waveform. For example, the processing module 230-a may determine heart rate (e.g., in beats per minute) based on the time between peaks in the pulse waveform. The time between peaks may be referred to as an interbeat interval (IBI). The processing module 230-a may store the determined heart rate values and IBI values in memory 215.

The processing module 230-a may determine HRV over time. For example, the processing module 230-a may determine HRV based on the variation in the IBIs. The processing module 230-a may store the HRV values over time in the memory 215. Moreover, the processing module 230-a may determine the user's respiratory rate over time. For example, the processing module 230-a may determine respiratory rate based on frequency modulation, amplitude modulation, or baseline modulation of the user's IBI values over a period of time. Respiratory rate may be calculated in breaths per minute or as another breathing rate (e.g., breaths per 30 seconds). The processing module 230-a may store user respiratory rate values over time in the memory 215.

The ring 104 may include one or more motion sensors 245, such as one or more accelerometers (e.g., 6-D accelerometers) and/or one or more gyroscopes (gyros). The motion sensors 245 may generate motion signals that indicate motion of the sensors. For example, the ring 104 may include one or more accelerometers that generate acceleration signals that indicate acceleration of the accelerometers. As another example, the ring 104 may include one or more gyro sensors that generate gyro signals that indicate angular motion (e.g., angular velocity) and/or changes in orientation. The motion sensors 245 may be included in one or more sensor packages. An example accelerometer/gyro sensor is a Bosch BM1160 inertial micro electro-mechanical system (MEMS) sensor that may measure angular rates and accelerations in three perpendicular axes.

The processing module 230-a may sample the motion signals at a sampling rate (e.g., 50 Hz) and determine the motion of the ring 104 based on the sampled motion signals. For example, the processing module 230-a may sample acceleration signals to determine acceleration of the ring 104. As another example, the processing module 230-a may sample a gyro signal to determine angular motion. In some implementations, the processing module 230-a may store motion data in memory 215. Motion data may include sampled motion data as well as motion data that is calculated based on the sampled motion signals (e.g., acceleration and angular values).

The ring 104 may store a variety of data described herein. For example, the ring 104 may store temperature data, such as raw sampled temperature data and calculated temperature data (e.g., average temperatures). As another example, the ring 104 may store PPG signal data, such as pulse waveforms and data calculated based on the pulse waveforms (e.g., heart rate values, IBI values, HRV values, and respiratory rate values). The ring 104 may also store motion data, such as sampled motion data that indicates linear and angular motion.

The ring 104, or other computing device, may calculate and store additional values based on the sampled/calculated physiological data. For example, the processing module 230 may calculate and store various metrics, such as sleep metrics (e.g., a Sleep Score), activity metrics, and readiness metrics. In some implementations, additional values/metrics may be referred to as “derived values.” The ring 104, or other computing/wearable device, may calculate a variety of values/metrics with respect to motion. Example derived values for motion data may include, but are not limited to, motion count values, regularity values, intensity values, metabolic equivalence of task values (METs), and orientation values. Motion counts, regularity values, intensity values, and METs may indicate an amount of user motion (e.g., velocity/acceleration) over time. Orientation values may indicate how the ring 104 is oriented on the user's finger and if the ring 104 is worn on the left hand or right hand.

In some implementations, motion counts and regularity values may be determined by counting a number of acceleration peaks within one or more periods of time (e.g., one or more 30 second to 1 minute periods). Intensity values may indicate a number of movements and the associated intensity (e.g., acceleration values) of the movements. The intensity values may be categorized as low, medium, and high, depending on associated threshold acceleration values. METs may be determined based on the intensity of movements during a period of time (e.g., 30 seconds), the regularity/irregularity of the movements, and the number of movements associated with the different intensities.

In some implementations, the processing module 230-a may compress the data stored in memory 215. For example, the processing module 230-a may delete sampled data after making calculations based on the sampled data. As another example, the processing module 230-a may average data over longer periods of time in order to reduce the number of stored values. In a specific example, if average temperatures for a user over one minute are stored in memory 215, the processing module 230-a may calculate average temperatures over a five minute time period for storage, and then subsequently erase the one minute average temperature data. The processing module 230-a may compress data based on a variety of factors, such as the total amount of used/available memory 215 and/or an elapsed time since the ring 104 last transmitted the data to the user device 106.

Although a user's physiological parameters may be measured by sensors included on a ring 104, other devices may measure a user's physiological parameters. For example, although a user's temperature may be measured by a temperature sensor 240 included in a ring 104, other devices may measure a user's temperature. In some examples, other wearable devices (e.g., wrist devices) may include sensors that measure user physiological parameters. Additionally, medical devices, such as external medical devices (e.g., wearable medical devices) and/or implantable medical devices, may measure a user's physiological parameters. One or more sensors on any type of computing device may be used to implement the techniques described herein.

The physiological measurements may be taken continuously throughout the day and/or night. In some implementations, the physiological measurements may be taken during portions of the day and/or portions of the night. In some implementations, the physiological measurements may be taken in response to determining that the user is in a specific state, such as an active state, resting state, and/or a sleeping state. For example, the ring 104 can make physiological measurements in a resting/sleep state in order to acquire cleaner physiological signals. In one example, the ring 104 or other device/system may detect when a user is resting and/or sleeping and acquire physiological parameters (e.g., temperature) for that detected state. The devices/systems may use the resting/sleep physiological data and/or other data when the user is in other states in order to implement the techniques of the present disclosure.

In some implementations, as described previously herein, the ring 104 may be configured to collect, store, and/or process data, and may transfer any of the data described herein to the user device 106 for storage and/or processing. In some aspects, the user device 106 includes a wearable application 250, an operating system (OS), a web browser application (e.g., web browser 280), one or more additional applications, and a GUI 275. The user device 106 may further include other modules and components, including sensors, audio devices, haptic feedback devices, and the like. The wearable application 250 may include an example of an application (e.g., “app”) that may be installed on the user device 106. The wearable application 250 may be configured to acquire data from the ring 104, store the acquired data, and process the acquired data as described herein. For example, the wearable application 250 may include a user interface (UI) module 255, an acquisition module 260, a processing module 230-b, a communication module 220-b, and a storage module (e.g., database 265) configured to store application data.

In some cases, the wearable device 104 and the user device 106 may be included within (or make up) the same device. For example, in some cases, the wearable device 104 may be configured to execute the wearable application 250, and may be configured to display data via the GUI 275.

The various data processing operations described herein may be performed by the ring 104, the user device 106, the servers 110, or any combination thereof. For example, in some cases, data collected by the ring 104 may be pre-processed and transmitted to the user device 106. In this example, the user device 106 may perform some data processing operations on the received data, may transmit the data to the servers 110 for data processing, or both. For instance, in some cases, the user device 106 may perform processing operations that require relatively low processing power and/or operations that require a relatively low latency, whereas the user device 106 may transmit the data to the servers 110 for processing operations that require relatively high processing power and/or operations that may allow relatively higher latency.

In some aspects, the ring 104, user device 106, and server 110 of the system 200 may be configured to evaluate sleep patterns for a user. In particular, the respective components of the system 200 may be used to collect data from a user via the ring 104, and generate one or more scores (e.g., Sleep Score, Readiness Score) for the user based on the collected data. For example, as noted previously herein, the ring 104 of the system 200 may be worn by a user to collect data from the user, including temperature, heart rate, HRV, and the like. Data collected by the ring 104 may be used to determine when the user is asleep in order to evaluate the user's sleep for a given “sleep day.” In some aspects, scores may be calculated for the user for each respective sleep day, such that a first sleep day is associated with a first set of scores, and a second sleep day is associated with a second set of scores. Scores may be calculated for each respective sleep day based on data collected by the ring 104 during the respective sleep day. Scores may include, but are not limited to, Sleep Scores, Readiness Scores, and the like.

In some cases, “sleep days” may align with the traditional calendar days, such that a given sleep day runs from midnight to midnight of the respective calendar day. In other cases, sleep days may be offset relative to calendar days. For example, sleep days may run from 6:00 pm (18:00) of a calendar day until 6:00 pm (18:00) of the subsequent calendar day. In this example, 6:00 pm may serve as a “cut-off time,” where data collected from the user before 6:00 pm is counted for the current sleep day, and data collected from the user after 6:00 pm is counted for the subsequent sleep day. Due to the fact that most individuals sleep the most at night, offsetting sleep days relative to calendar days may enable the system 200 to evaluate sleep patterns for users in such a manner that is consistent with their sleep schedules. In some cases, users may be able to selectively adjust (e.g., via the GUI) a timing of sleep days relative to calendar days so that the sleep days are aligned with the duration of time that the respective users typically sleep.

In some implementations, each overall score for a user for each respective day (e.g., Sleep Score, Readiness Score) may be determined/calculated based on one or more “contributors,” “factors,” or “contributing factors.” For example, a user's overall Sleep Score may be calculated based on a set of contributors, including: total sleep, efficiency, restfulness, REM sleep, deep sleep, latency, timing, or any combination thereof. The Sleep Score may include any quantity of contributors. The “total sleep” contributor may refer to the sum of all sleep periods of the sleep day. The “efficiency” contributor may reflect the percentage of time spent asleep compared to time spent awake while in bed, and may be calculated using the efficiency average of long sleep periods (e.g., primary sleep period) of the sleep day, weighted by a duration of each sleep period. The “restfulness” contributor may indicate how restful the user's sleep is, and may be calculated using the average of all sleep periods of the sleep day, weighted by a duration of each period. The restfulness contributor may be based on a “wake up count” (e.g., sum of all the wake-ups (when user wakes up) detected during different sleep periods), excessive movement, and a “got up count” (e.g., sum of all the got-ups (when user gets out of bed) detected during the different sleep periods).

The “REM sleep” contributor may refer to a sum total of REM sleep durations across all sleep periods of the sleep day including REM sleep. Similarly, the “deep sleep” contributor may refer to a sum total of deep sleep durations across all sleep periods of the sleep day including deep sleep. The “latency” contributor may signify how long (e.g., average, median, longest) the user takes to go to sleep, and may be calculated using the average of long sleep periods throughout the sleep day, weighted by a duration of each period and the number of such periods (e.g., consolidation of a given sleep stage or sleep stages may be its own contributor or weight other contributors). Lastly, the “timing” contributor may refer to a relative timing of sleep periods within the sleep day and/or calendar day, and may be calculated using the average of all sleep periods of the sleep day, weighted by a duration of each period.

By way of another example, a user's overall Readiness Score may be calculated based on a set of contributors, including: sleep, sleep balance, heart rate, HRV balance, recovery index, temperature, activity, activity balance, or any combination thereof. The Readiness Score may include any quantity of contributors. The “sleep” contributor may refer to the combined Sleep Score of all sleep periods within the sleep day. The “sleep balance” contributor may refer to a cumulative duration of all sleep periods within the sleep day. In particular, sleep balance may indicate to a user whether the sleep that the user has been getting over some duration of time (e.g., the past two weeks) is in balance with the user's needs. Typically, adults need 7-9 hours of sleep a night to stay healthy, alert, and to perform at their best both mentally and physically. However, it is normal to have an occasional night of bad sleep, so the sleep balance contributor takes into account long-term sleep patterns to determine whether each user's sleep needs are being met. The “resting heart rate” contributor may indicate a lowest heart rate from the longest sleep period of the sleep day (e.g., primary sleep period) and/or the lowest heart rate from naps occurring after the primary sleep period.

Continuing with reference to the “contributors” (e.g., factors, contributing factors) of the Readiness Score, the “HRV balance” contributor may indicate a highest HRV average from the primary sleep period and the naps happening after the primary sleep period. The HRV balance contributor may help users keep track of their recovery status by comparing their HRV trend over a first time period (e.g., two weeks) to an average HRV over some second, longer time period (e.g., three months). The “recovery index” contributor may be calculated based on the longest sleep period. Recovery index measures how long it takes for a user's resting heart rate to stabilize during the night. A sign of a very good recovery is that the user's resting heart rate stabilizes during the first half of the night, at least six hours before the user wakes up, leaving the body time to recover for the next day. The “body temperature” contributor may be calculated based on the longest sleep period (e.g., primary sleep period) or based on a nap happening after the longest sleep period if the user's highest temperature during the nap is at least 0.5° C. higher than the highest temperature during the longest period. In some aspects, the ring may measure a user's body temperature while the user is asleep, and the system 200 may display the user's average temperature relative to the user's baseline temperature. If a user's body temperature is outside of their normal range (e.g., clearly above or below 0.0), the body temperature contributor may be highlighted (e.g., go to a “Pay attention” state) or otherwise generate an alert for the user.

In some aspects, the system 200 may support techniques for a charging device (e.g., a portable charger for a wearable device 104) without a battery. For example, the charging device may include one or more portions that may be reconfigured into a first charging orientation and a second charging orientation. In the first charging orientation, the charging device may include a flange that may be on a same side of a charger post as a power receiving component (e.g., such that the wearable device 104 may be easily removed from the charger base). In the second charging orientation, the charging device may include the flange that may be on a different (e.g., opposite) side of the charger post as the power receiving component (e.g., such that the wearable device 104 may not be easily removed from the charger base when the power receiving component is coupled to an external power source).

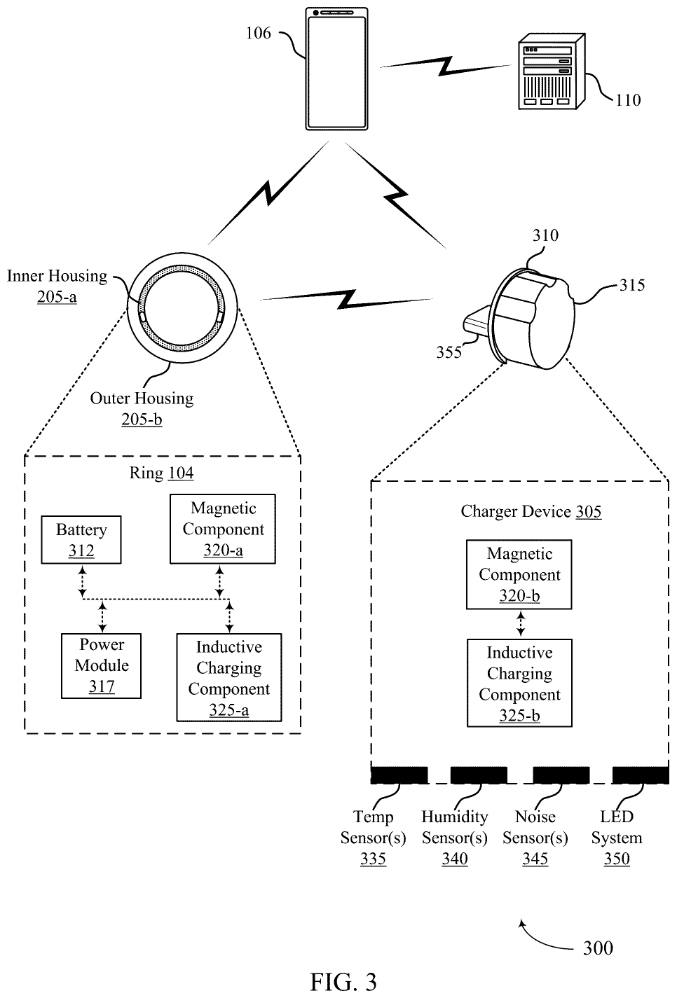

FIG. 3 shows an example of a system 300 that supports a portable charger without a battery for wearable devices in accordance with aspects of the present disclosure. The system 300 may implement, or be implemented by system 100, system 200, or both. In particular, system 300 illustrates an example of a ring 104 (e.g., wearable device 104), as described with reference to FIGS. 1 and 2, and a charger device 305.

In some aspects, the ring 104 may be configured to be worn around a user's finger and may measure one or more user physiological parameters when worn around the user's finger. Example measurements and determinations may include, but are not limited to, user skin temperature, pulse waveforms, respiratory rate, heart rate, HRV, blood oxygen levels, and the like.

The system 300 further includes a charger device 305. The ring 104 may be in wireless and/or wired communication with a user device 106 and/or server 110. Similarly, the charger device 305 may be in wireless and/or wired communication with a user device 106, the ring 104, a server 110, or any combination thereof. In some implementations, the charger device 305 may send measured and processed data (e.g., temperature data, humidity data, noise data, and the like) to the user device 106, the ring 104, or both. Various data processing procedures described herein may be performed by any of the components of system 300, including the ring 104, charger device 305, user device 106, server 110, or any combination thereof. In this regard, the charger device 305 (e.g., charger device) may include one or more processors. As will be described in further detail herein, the one or more processors of the charger device 305 may be configured to evaluate physiological data collected from the ring 104 in order to identify satisfaction of trigger conditions used to trigger the display system 350 to display different types of data/information.

Data may be collected and analyzed via one or more components of the system 300. Moreover, in some implementations, the charger device 305 may be configured to collect and analyze data, including ambient temperature data, noise data, and the like. For example, the user device 106 may determine a correlation between sleep data from the ring 104 and the measured and processed data from the charger device 305 (e.g., if the air temperature is relatively high, a user of the ring 104 may wake up throughout a sleep duration). In other words, data collected via the charger device 305 (e.g., ambient air temperature data, noise data) may be used to further analyze physiological data collected via the ring 104, and identify relationships between the user's physiological data and their surrounding environment (e.g., how the user's surroundings affect their physiological data).

The ring 104 may include an inner housing 205-a and an outer housing 205-b, as described with reference to FIG. 2. In some aspects, the housing 205 of the ring 104 may store or otherwise include various components of the ring 104 including, but not limited to, device electronics (e.g., a power module 317, which may be an example of a power module 225 as described with reference to FIG. 2), a power source (e.g., battery 312, which may be an example of a battery 210 as described with reference to FIG. 2, and/or capacitor), one or more substrates (e.g., printable circuit boards) that interconnect the device electronics and/or power source, and the like. In some examples, the housing 205 may also store a magnetic component 320-a (e.g., ferrite tape, other charging magnet, a transmitter coil, a rare earth magnet, or the like) and an inductive charging component 325 (e.g., inductive charging component 325-a).

The ring 104 shown and described with reference to FIGS. 2 and 3 is provided solely for illustrative purposes. As such, the ring 104 may include additional or alternative components as those illustrated in FIGS. 2 and 3. Other rings 104 that provide functionality described herein may be fabricated. For example, rings 104 with fewer components (e.g., sensors) may be fabricated. In a specific example, a ring 104 may include ferrite tape, which may act as both the magnetic component 320-a and the inductive charging component 325-a. In other cases, the ring 104 may include a dedicated charger magnet. For example, the ring 104 may include a metal plate and/or ferrite tape disposed proximate to a charger magnet.

In some cases, the ring 104 may be in electronic communication with the charger device 305. The charger device 305 may charge the battery 312 of the ring 104. The charger device 305 may include a support, which may store or otherwise include various components of the charger device 305. In some aspects, the support of the charger device 305 may store or otherwise include various components of the charger device 305 including, but not limited to, a magnetic component 320-b (e.g., ferrite tape, a transmitter coil, a rare earth magnet, or the like) and an inductive charging component 325-b.

In some cases, the magnetic component 320-b of the charger device 305 may include multiple magnets arranged according to a pattern based on a polarity of each magnet. For example, each magnet may have a polarity facing outward towards the surface of the charger device 305 to attract the magnetic component 320-a of the ring 104 with an opposite polarity. The charging component 325-b of the charger device 305 (e.g., transmitter coil, ferrite tape) may couple with charging component 325-a of the ring 104 (e.g., receiver coil, ferrite tape) to charge the battery 312 of the ring 104. In some examples, the charging component 325-a and the charging component 325-b may support charging of the battery 312 via direct electrical coupling (e.g., of contacts at the surface of the charger device 305 and the ring 104). Additionally, or alternatively, the charging component 325-a and the charging component 325-b may be examples of inductive charging components, which may support charging of the battery 312 via indirect electrical coupling. Inductive charging may also be referred to as wireless charging and may allow power to transfer from the charger device 305 to the battery 312 of the ring 104 using electromagnetic induction.

In some cases, the ring 104 may be configured to fit around a support 315 (e.g., charging post) of the charger device 305, where the magnetic components 320-b are configured to attract the magnetic components 320-b and to align the ring 104 in the correct radial orientation for charging and secure the ring 104 onto the charger device 305. That is, the magnetic components 320 may be configured to align the inductive charging components 325 to facilitate inductive charging for the ring. In some cases, the charger device 305 may include one or more indentation features (e.g., on an external radial surface of the support 315) that may be configured to receive one or more protrusions (e.g., dome-shaped protrusions) of the ring 104 when the ring is placed onto the charger device 305 (e.g., in the correct radial orientation).

In some examples, the charger device 305 may include one or more temperature sensors 335. The temperature sensors 335 may measure an average air temperature over a duration, may continuously measure air temperature, or both. Similarly, the charger device 305 may include one or more humidity sensors 340. The humidity sensors 340 may measure an average humidity level over a duration, may continuously measure humidity level, or both. The humidity sensors 340 may measure the humidity as a percentage (e.g., 35% humidity). The charger device 305 may include one or more noise sensors 345. The noise sensors 345 may measure a noise level (e.g., in decibels) averaged over a duration, continuously, or both. The charger device 305 may store the humidity measurements, the temperature measurements, the noise measurements, or a combination thereof.

The charger device 305 may include any type of sensor known in the art and may be configured to collect any type of data which may be used to provide insight into a user's environment and overall health. For example, the charger device 305 may include light sensors configured to measure an amount of light and/or type of light (e.g., wavelength). In such cases, the system 300 may be configured to determine whether light levels and/or which types of light may result positively or negatively affect a user's sleep and health (e.g., determine if blue light is more disruptive to a user's sleep as compared to red light). By way of another example, the charger device 305 may include air quality sensors configured to measure air quality, pollutants, allergens, and the like. Data collected via sensors of the charger device 305 may be leveraged to determine how a user's surrounding environment may affect their physiological data, sleep, and overall health. A processing module, such as a processing module 230 as described with reference to FIG. 2, at the user device 106 or at the charger device 305 may process the data from the temperature sensors 335, the humidity sensors 340, the noise sensors 345, light sensors, air quality sensors, or a combination thereof.

In some examples, the user device 106 and/or charger device 305 may process the data from the temperature sensors 335, the humidity sensors 340, the noise sensors 345, or a combination thereof in conjunction with data from the ring 104. For example, the user device 106 may receive physiological data collected by the ring 104 which reflects one or more sleep cycles of a user and may use the data from the sensors at the charger device 305 to determine a correlation between the collected physiological data and data collected by the charger device 305. For example, the user device 106 may determine a correlation over a time interval between data collected by the charger device 305 (e.g., ambient temperature data, humidity data, noise data, and the like) with a quality of sleep for the user (as determined by collected physiological data). In other words, the system 300 may be configured to identify whether high/low temperature, humidity, and/or noise levels result in a disruption of the user's sleep cycles (e.g., low ambient temperature and humidity levels result in higher quality sleep, higher noise levels result in lower quality sleep).

Although the charger device 305 is illustrated as including temperature sensors 335, humidity sensors 340, and noise sensors 345, the charger device 305 may include any quantity and type of sensors in one or more locations. For example, the charger device 305 may also include a motion sensor, a light sensor, or the like.

In some implementations, the charger device 305 may include a wired or wireless power source. For example, in some cases, the charger device 305 may be coupled with an electrical outlet or other power source. The charger device 305 may therefore include a power receiving component 355 (e.g., a USB-C connector) to receive power from one or more external sources (e.g., an outlet, a user device, a computer, and so on). In other cases, the charger device 305 may be coupled with the ring 104 (e.g., magnetically coupled, mechanically snapped onto) the ring 104 while the ring 104 is being worn so that the ring 104 may be charged (and continue to collect physiological data) as it is worn.

In some cases, the charger device 305 may include a display system 350. The display system 350 may display one or more indications to a user of the ring 104 (e.g., via one or more LEDs, OLEDs, or an LCD). For example, the display system 350 may display a battery level of the battery 312, a battery health/charge status (e.g., end of battery life), a time of day, connectivity issues, and so on. The display system 350 may, additionally, or alternatively, display one or more alerts to the user (e.g., action items prompting the user to perform an action, and the like). In some examples, the display system 350 may display a battery level of the battery 312 of the ring 104 as a percentage of total battery by displaying the numbers of the percentage, by illuminating a portion of LEDs (e.g., if a battery level is at 50%, 5 of 10 LEDs may be displayed), or the like. The LEDs in the display system 350 may be oriented in any arrangement on the charger device 305, may be any color combination (e.g., red LED, blue LED, green LED), and there may be any quantity of LEDs in the display system 350.

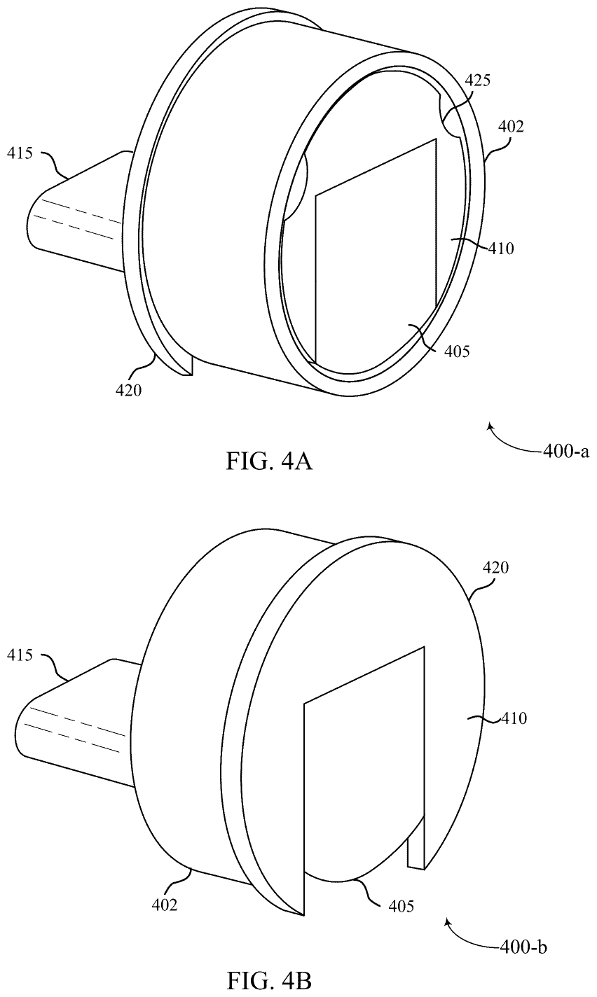

In some cases, the charger device 305 may include one or more parts that may be reconfigured to various charging positions. For example, the support 315 may include a flange 310 that may be configured to prevent the ring 104 from sliding off of the charger device 305. In some examples, the charger device 305 may be reconfigured into a first charging orientation in which the flange 310 is on a same side of the support 315 as the power receiving component 355 and a second charging orientation in which the flange 310 is on a different (e.g., opposite) side of the support 315 as the power receiving component 355. Accordingly, the charger device 305 may support the first charging orientation in which the ring 104 may be removed from the charger device 305 when the power receiving component 355 is coupled with an external power source and the second charging orientation in which the ring 104 may not be removed from the charger device 305 when the power receiving component 355 is coupled with an external power source. The first and second charging orientations are described herein in further detail with reference to FIGS. 4-6.

FIGS. 4A and 4B show examples of a charging diagram 400-a and a charging diagram 400-b that support a portable charger without a battery for wearable devices in accordance with aspects of the present disclosure. The charging diagrams 400 may implement or may be implemented by aspects of the system 100, the system 200, or the system 300. For example, the charging diagrams 400 illustrate examples of a wearable ring device 402 and a charging device, as described herein with reference to FIGS. 1 through 3.

As illustrated with reference to the charging diagrams 400, a charging device for a wearable ring device 402 may include a charging post 405 and a support post 410. The charging post 405 may include an outer housing (e.g., a plastic housing), a power receiving component 415, and at least one charging component (e.g., inductive charging component, charging coil) configured to charge a rechargeable battery of the wearable ring device 402 by transferring power from the power receiving component 415 to the wearable ring device 402. For example, the power receiving component may be a plug (e.g., a USB-C plug) that may connect (e.g., plug in) to an external power source. The external power source may be, for example, a laptop computer, a cell phone, a rechargeable portable battery, a power outlet, and so on. The charging post 405 may comprise one or more circuit components (e.g., a PCB module, a printed wiring board (PWB) module) to transfer power from the power receiving component 415 to the at least one charging component. The charging component may accordingly charge the rechargeable battery of the wearable ring device 402 when an inductive charging component of the wearable ring device 402 is within a threshold distance from (e.g., in contact with) the at least one charging component.

The support post 410 may be configured to receive the wearable ring device 402. For example, the support post 410 may have an outer circumferential surface that is smaller in diameter than an inner circumferential surface of the wearable ring device 402 such that the wearable ring device 402 may fit around the support post 410. In some examples, the support post 410 may include a receiving “hole” in which the charging post 405 may fit. For example, the receiving hole may extend through a width of the support post, and may overlap a portion of the outer circumferential surface of the support post 410. Accordingly, at least one portion of an outer surface of the charging post 405 may be in contact with a portion of the inner circumferential surface of the wearable ring device 402 when the support post is positioned within the receiving hole and when the wearable ring device 402 is mounted onto the charging device. The inductive charging component of the wearable ring device 402 may therefore be within the threshold distance from (e.g., in contact with) the one or more charging components of the charging post 405 when the wearable ring device 402 is mounted onto the charging device.

In some examples, a size of the charging device or one or more components of the charging device (e.g., the support post 410) may be based on a size of the wearable ring device 402. For example, the support post 410 may be a ring-specific support post 410 with a diameter that is specific to a diameter of the wearable ring device 402. In some examples, a size of the charging device or one or more components of the charging device may be adjustable (e.g., to accommodate multiple sizes of the wearable ring device 402). For example, one or more components of the charging device (e.g., the support post 410, one or more components of the support post 410) may move in relation to one another to change a diameter size and therefore to fit more than one size of wearable ring device 402. In some examples, the charging device may include one or more magnetic components configured to attract one or more magnetic components of the wearable ring device 402 (e.g., to secure the wearable ring device onto the charging device).

In some examples, the support post 410 may include one or more indentations 425 along the outer circumferential surface that may be configured to receive one or more protrusions (e.g., dome-shaped protrusions) along the inner circumferential surface of the wearable ring device 402. That is, to mount the wearable ring device 402 onto the charging device, a user may orient the wearable ring device 402 in a first radial position in which the one or more protrusions are aligned with the one or more indentations 425 of the support post 410. The user may accordingly “slide” the wearable ring device 402 onto the charging device in the radial orientation such that the one or more indentations 425 receive the one or more protrusions.

The radial orientation may be an orientation in which the inductive charging component of the wearable ring device 402 is within the threshold distance from (e.g., in contact with) the one or more charging components of the charging post 405. As an illustrative example, with reference to FIGS. 4A and 4B, in the radial orientation, the inductive charging component of the wearable ring device may be along a bottom of the inner circumferential surface of the wearable ring device 402, and the one or more charging components of the charging post 405 may be along a bottom of the outer circumferential surface of the charging device (e.g., on the charging post 405).

The support post 410 may include a retaining component 420 (e.g., a flange component). The retaining component 420 may be on one side of the support post 410 (e.g., in a first position along the width of the support post 410). The retaining component 420 may have a diameter that is greater than the diameter of the outer circumferential surface of the support post 410. For example, the retaining component 420 may have a diameter that is greater than the diameter of the inner circumferential surface of the wearable ring device 402 such that the wearable ring device 402 may not slide off of the support post 410 over the retaining component 420. That is, the user may remove the wearable ring device 402 from the charging device by sliding the wearable ring device 402 in a direction away from the retaining component 420, but may not remove the wearable ring device 402 from the charging device by sliding the wearable ring device 402 in a direction towards the retaining component 420.

The charging device may be configured to transition between more than one charging orientations. For example, the charging device may be configured to operate (e.g., to charge the wearable ring device 402) in a first charging orientation (e.g., a “home” orientation, as illustrated with reference to FIG. 4A) or in a second charging orientation (e.g., a “travel” orientation, as illustrated with reference to FIG. 4B).

As illustrated with reference to FIG. 4A, in the first charging orientation, the retaining component 420 may be on a same side of the support post 410 as the power receiving component 415. Accordingly, the user of the charging device may easily slide the wearable ring device 402 onto and off of the charging device when the power receiving component is connected to an external power source (e.g., when the charging device is plugged in).

As illustrated with reference to FIG. 4B, in the second charging orientation, the retaining component 420 may be on a different side of the support post 410 from the power receiving component 415 (e.g., an opposite side). Accordingly, the user of the charging device may not easily slide the wearable ring device 402 onto and off of the charging device when the power receiving component is connected to an external power source (e.g., when the charging device is plugged in). That is, the user may slide the wearable ring device 402 onto the charging device prior to plugging the charging device into an external power source. The user may remove (e.g., unplug) the charging device from the external power source prior to removing the wearable ring device 402 from the charging device. Accordingly, in the second charging orientation, the wearable ring device 402 may be secured onto the charging device, and the user may therefore travel while charging the wearable ring device 402 (e.g., charging from a portable power source, such as a cell phone, laptop, or portable battery) without the wearable ring device 402 moving off of the charging device.

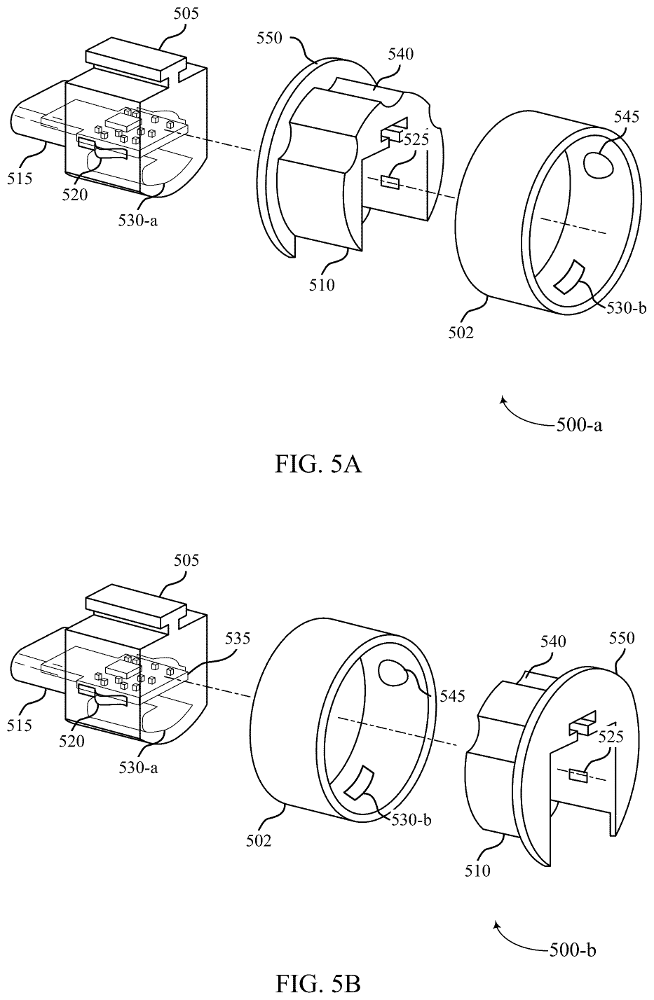

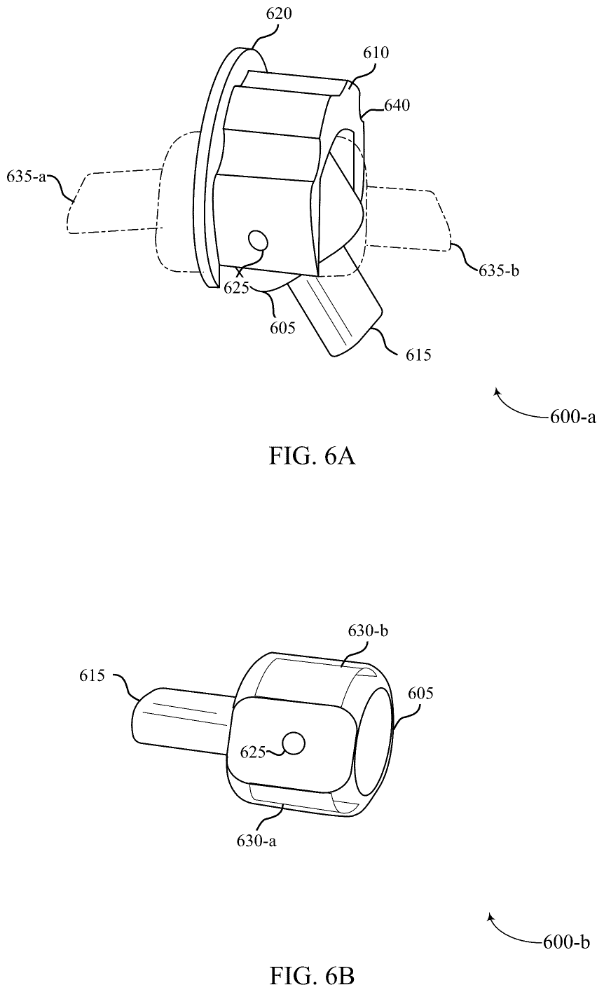

In some examples, to transition between the first charging orientation and the second charging orientation, the charging device may comprise separate pieces (e.g., a separate support post 410 and a separate or removable charging post 405) that may interface (e.g., connect) in either of the first charging orientation or the second charging orientation. Such a charging device is described in further detail with reference to FIGS. 5A and 5B. Additionally, or alternatively, the charging device may comprise a hinge component connecting the charging post 405 and the support post 410. The charging device may therefore transition between the first charging orientation and the second charging orientation via the hinge component. Such a charging device is described in further detail with reference to FIGS. 6A and 6B.

FIGS. 5A and 5B show examples of a charging diagram 500-a and a charging diagram 500-b that support a portable charger without a battery for wearable devices in accordance with aspects of the present disclosure. The charging diagrams 500 may implement or may be implemented by aspects of the system 100, the system 200, the system 300, or the charging diagrams 400. For example, the charging diagrams 500 illustrate examples of a wearable ring device 502 and a charging device, as described herein with reference to FIGS. 1 through 4.

In some aspects, a charging device for a wearable ring device 502 may include a charging post 505 and a removable support post 510. The charging post 505 may include an outer housing (e.g., a plastic housing) encasing one or more circuit components (e.g., a PCB or PWB module 535), a power receiving component 515 (e.g., a USB-C connector), and a charging component 530-a (e.g., an inductive charging component). The PWB module 535 may be configured to transfer power from an external power source (e.g., an external battery, a laptop device, a phone, a wall outlet) via the power receiving component 515 to the charging component 530-a to charge a rechargeable battery of the wearable ring device 502. For example, the charging component 530-a may charge the rechargeable battery of the wearable ring device 502 when the charging component 530-a is within a threshold distance from (e.g., in contact with) a charging component 530-b of the wearable ring device 502.

The removable support post 510 may be configured to interface with the charging post 505 via a receiving “hole” in the support post 510. That is, the support post 510 may have an outer circumferential surface, and may have a hole that extends through the width of the support post 510 such that the charging post 505 may fit within the support post 510. The receiving hole may overlap a portion of the outer circumferential surface such that a portion of the support post 510 (e.g., the charging component 530-a) may be uncovered by the support post 510. Accordingly, the charging component 530-a may be within the threshold distance from (e.g., in contact with) the charging component 530-b when the wearable ring device 502 is mounted onto the charging device. In some examples, the charging component 530-a may align with the outer circumferential surface of the support post 510 when the charging post 505 is positioned within the receiving hole.

In some examples, the removable support post 510 and the charging post 505 may comprise one or more components configured to secure the charging post 505 within the receiving hole of the support post 510. For example, the receiving hole of the support post 510 may comprise a shaped hole portion (e.g., a T-shaped portion, as illustrated with reference to FIGS. 4A and 4B), and the charging post 505 may comprise a shaped protrusion portion configured to fit within the shaped hole portion. Accordingly, the charging post 505 may not slide out of the gap in the outer circumferential surface of the support post 510.

Additionally, or alternatively, an interior wall of the receiving hole of the support post 510 may include one or more indentations 525 configured to interface with one or more clip portions 520 (e.g., metal clips) of the charging post 505. In some examples, the one or more clip portions 520 may compress inwards towards an outer surface of the housing of the charging post 505 while a user “slides” the charging post into the receiving hole. The one or more clip portions 520 may decompress outwards into the one or more indentations 525 such that the charging post 505 may not slide out of the receiving hole (e.g., until the user applies a threshold amount of pressure to compress the clip portions 520 and push the charging post 505 out of the receiving hole).

In some examples, the outer circumferential surface of the support post may include one or more indentations 540 configured to receive one or more protrusions 545 on an inner circumferential surface of the wearable ring device 502 (e.g., protrusions housing one or more components configured to perform measurements of physiological data of the user). For example, to mount the wearable ring device 502 onto the charging device, the user may orient the wearable ring device 502 in a radial orientation in which the one or more protrusions 545 are aligned with the one or more indentations 540 of the support post 510. The user may accordingly “slide” the wearable ring device 502 onto the charging device in the radial orientation such that the one or more indentations 540 receive the one or more protrusions 545.

The radial orientation may be an orientation in which the charging component 530-b of the wearable ring device 502 is within the threshold distance from (e.g., in contact with) the charging component 530-a of the charging post 505. As an illustrative example, with reference to FIGS. 5A and 5B, in the radial orientation, the charging component 530-b may be along a bottom of the inner circumferential surface of the wearable ring device 502, and the charging component 530-a of the charging post 505 may be along a bottom of the outer circumferential surface of the charging device (e.g., on the charging post 505).

The removable support post 510 may include a retaining component 550 (e.g., a flange component). The retaining component 550 may be on one side of the support post 510 (e.g., in a first position along the width of the support post 510). The retaining component 550 may have a diameter that is greater than the diameter of the outer circumferential surface of the support post 510. For example, the retaining component 550 may have a diameter that is greater than the diameter of the inner circumferential surface of the wearable ring device 502 such that the wearable ring device 502 may not slide off of the support post 510 over the retaining component 550. That is, the user may remove the wearable ring device 502 from the charging device by sliding the wearable ring device 502 in a direction away from the retaining component 550, but may not remove the wearable ring device 502 from the charging device by sliding the wearable ring device 502 in a direction towards the retaining component 550.

The removable support post 510 may be configured to interface with the charging post 505 in more than one charging orientation. For example, the charging post 505 may slide into the receiving hole of the removable support post 510 in a first charging orientation (e.g., a “home” orientation, as illustrated with reference to FIG. 5A) or in a second charging orientation (e.g., a “travel” orientation, as illustrated with reference to FIG. 5B). In some examples, the one or more indentations 525 in the inner wall of the receiving hole of the support post 510 may be configured to interface with the one or more clip portions 520 in either of the first charging orientation or the second charging orientation.

As illustrated with reference to FIG. 5A, in the first charging orientation (e.g., a “home” orientation), the retaining component 550 may be on a same side of the support post 510 as the power receiving component 515. Such a charging orientation is described in further detail with reference to FIG. 4A. As illustrated with reference to FIG. 5B, in the second charging orientation (e.g., a “travel” orientation), the retaining component 550 may be on a different side of the support post 510 from the power receiving component 515 (e.g., an opposite side). Such a charging orientation is described in further detail with reference to FIG. 4B.

In some examples, a size of the removable support post 510 may be based on a size of the wearable ring device 502. For example, a diameter of the outer circumferential surface of the support post 510 may be smaller than a diameter of the inner circumferential surface of the wearable ring device 502 such that the wearable ring device 502 may fit around the support post 510 (e.g., excepting the retaining component 550). In some examples, one or more other removable support posts (e.g., of one or more other sizes different from the size of the removable support post 510) may be configured to interface with the charging post 505. Accordingly, the user may charge a different wearable ring device (e.g., of a different size than the wearable ring device 502) using the charging post 505 and the one or more other removable support posts. In such examples, the one or more other removable support posts may comprise receiving holes that are a same size and shape as the receiving hole of the support post 510 (e.g., to fit around the charging post 505).

FIGS. 6A and 6B show examples of a charging diagram 600-a and a charging diagram 600-b that support a portable charger without a battery for wearable devices in accordance with aspects of the present disclosure. The charging diagrams 600 may implement or may be implemented by aspects of the system 100, the system 200, the system 300, the charging diagrams 400, or the charging diagrams 500. For example, the charging diagrams 600 may be implemented by a wearable device 102 (e.g., a ring, a bracelet, or another device) and may include a charging device, as described herein with reference to FIGS. 1 through 5.

In some aspects, a charging device for a wearable ring device may include a charging post 605 and a support post 610. The charging post 605 may include an outer housing (e.g., a plastic housing) encasing one or more circuit components (e.g., a PCB or PWB module), a power receiving component 615 (e.g., a USB-C connector), and a charging component 630-a and a charging component 630-b (e.g., inductive charging components). The PWB module may be configured to transfer power from an external power source (e.g., a rechargeable portable battery, a laptop device, a cell phone, a wall outlet) via the power receiving component 615 to the charging component 630-a and/or the charging component 530-b to charge a rechargeable battery of the wearable ring device. For example, the charging component 630-a and/or the charging component 630-b may charge the rechargeable battery of the wearable ring device when one of the charging component 630-a or the charging component 630-b is within a threshold distance from (e.g., in contact with) an inductive charging component of the wearable ring device.

The support post 610 may be connected to the charging post 605 via a hinge component 625. The hinge component 625 may rotate the charging post 605 with respect to the support post 610 (e.g., from a first charging orientation 635-a to a second charging orientation 635-b). In some examples, the charging component 630-a and the charging component 630-b may be in a first position and a second position, respectively, on a circumferential surface of the charging post 605. Accordingly, the charging component 630-a may align with the outer circumferential surface of the support post 510 when the charging post 605 is in the charging orientation 635-a and the charging component 630-b may align with the outer circumferential surface of the support post 610 when the charging post 605 is in the charging orientation 635-b.

In some examples, the outer circumferential surface of the support post may include one or more indentations 640 configured to receive one or more protrusions on an inner circumferential surface of the wearable device (e.g., protrusions housing one or more components configured to perform measurements of physiological data of a user). For example, to mount the wearable ring device onto the charging device, the user may orient the wearable ring device in a radial orientation in which the one or more protrusions are aligned with the one or more indentations 640 of the support post 610. The user may accordingly “slide” the wearable ring device onto the charging device in the radial orientation such that the one or more indentations 640 receive the one or more protrusions.

The radial orientation may be an orientation in which the inductive charging component of the wearable ring device is within the threshold distance from (e.g., in contact with) the charging component 630-a or the charging component 630-b of the charging post 605. As an illustrative example, with reference to FIGS. 5A and 5B, in the radial orientation, the inductive charging component of the wearable ring device may be along a bottom of the inner circumferential surface of the wearable ring device. In the charging orientation 635-a, the charging component 630-a of the charging post 605 may be along a bottom of the outer circumferential surface of the charging device. In the charging orientation 635-b, the charging component 630-b of the charging post 605 may be along a bottom of the outer circumferential surface of the charging device.

The support post 610 may include a retaining component 620 (e.g., a flange component). The retaining component 620 may be on one side of the support post 610 (e.g., in a first position along the width of the support post 610). The retaining component 620 may have a diameter that is greater than the diameter of the outer circumferential surface of the support post 610. For example, the retaining component 620 may have a diameter that is greater than the diameter of the inner circumferential surface of the wearable ring device such that the wearable ring device may not slide off of the support post 610 over the retaining component 620. That is, the user may remove the wearable ring device from the charging device by sliding the wearable ring device in a direction away from the retaining component 620, but may not remove the wearable ring device from the charging device by sliding the wearable ring device in a direction towards the retaining component 620. In some examples, a size of the charging device (e.g., including the support post 610 and the charging post 605) may be based on a size of the wearable ring device. For example, a diameter of the outer circumferential surface of the charging device may be smaller than a diameter of the inner circumferential surface of the wearable ring device such that the wearable ring device may fit around the charging device (e.g., excepting the retaining component 620).

The charging device may be configured to transition between the charging orientation 635-a and the charging orientation 635-b via the hinge component 625. In the charging orientation 635-a (e.g., a “home” orientation), the retaining component 620 may be on a same side of the support post 610 as the power receiving component 615. Such a charging orientation is described in further detail with reference to FIG. 4A. In the charging orientation 635-b (e.g., a “travel” orientation), the retaining component 620 may be on a different side of the support post 610 from the power receiving component 615 (e.g., an opposite side). Such a charging orientation is described in further detail with reference to FIG. 4B.

It should be noted that the methods described above describe possible implementations, and that the operations and the steps may be rearranged or otherwise modified and that other implementations are possible. Furthermore, aspects from two or more of the methods may be combined.

A method by an apparatus is described. The method may include a support post configured to receive a wearable ring device, the support post comprising a retaining component configured to retain the wearable ring device onto the support post, a charging post comprising an outer housing, a power receiving component configured to receive power from one or more external power sources, and a first charging component configured to transfer the power from the power receiving component to the wearable ring device to recharge a rechargeable battery of the wearable ring device, wherein the charging device is configured to, and transition between a first charging orientation and a second charging orientation, wherein the first charging orientation comprises an orientation in which the retaining component is on a same side of the support post as the power receiving component and the second charging orientation comprises an orientation in which the retaining component is on a different side of the support post from the power receiving component.

An apparatus is described. The apparatus may include one or more memories storing processor executable code, and one or more processors coupled with the one or more memories. The one or more processors may individually or collectively be operable to execute the code to cause the apparatus to a support post configure to receive a wearable ring device, the support post comprising a retaining component configured to retain the wearable ring device onto the support post, a charge post comprising an outer housing, a power receiving component configured to receive power from one or more external power sources, and a first charging component configured to transfer the power from the power receiving component to the wearable ring device to recharge a rechargeable battery of the wearable ring device, wherein the charging device is configured to, and transition between a first charge orientation and a second charging orientation, wherein the first charging orientation comprises an orientation in which the retaining component is on a same side of the support post as the power receiving component and the second charging orientation comprises an orientation in which the retaining component is on a different side of the support post from the power receiving component.

Another apparatus is described. The apparatus may include means for a support post configured to receive a wearable ring device, the support post comprising a retaining component configured to retain the wearable ring device onto the support post, means for a charging post comprising an outer housing, a power receiving component configured to receive power from one or more external power sources, and a first charging component configured to transfer the power from the power receiving component to the wearable ring device to recharge a rechargeable battery of the wearable ring device, wherein the charging device is configured to, and means for transition between a first charging orientation and a second charging orientation, wherein the first charging orientation comprises an orientation in which the retaining component is on a same side of the support post as the power receiving component and the second charging orientation comprises an orientation in which the retaining component is on a different side of the support post from the power receiving component.

A non-transitory computer-readable medium storing code is described. The code may include instructions executable by one or more processors to a support post configure to receive a wearable ring device, the support post comprising a retaining component configured to retain the wearable ring device onto the support post, a charge post comprising an outer housing, a power receiving component configured to receive power from one or more external power sources, and a first charging component configured to transfer the power from the power receiving component to the wearable ring device to recharge a rechargeable battery of the wearable ring device, wherein the charging device is configured to, and transition between a first charge orientation and a second charging orientation, wherein the first charging orientation comprises an orientation in which the retaining component is on a same side of the support post as the power receiving component and the second charging orientation comprises an orientation in which the retaining component is on a different side of the support post from the power receiving component.

In some examples of the method, apparatus, and non-transitory computer-readable medium described herein, the charging device may include operations, features, means, or instructions for a hinge component connecting the support post and the charging post, wherein, to transition between the first charging orientation and the second charging orientation, the hinge component may be configured to and rotate the charging post with respect to the support post.

In some examples of the method, apparatus, and non-transitory computer-readable medium described herein, a second charging component configured to transfer the power from the power receiving component to the wearable ring device to recharge the rechargeable battery of the wearable ring device, wherein the first charging component and the second charging component may be located on a first position on a circumferential surface of the charging post and a second position on the circumferential surface of the charging post, respectively.

In some examples of the method, apparatus, and non-transitory computer-readable medium described herein, the first charging component may be positioned on an outer circumferential surface of the charging device when the charging device may be in the first charging orientation and the second charging component may be positioned on the outer circumferential surface of the charging device when the charging device may be in the second charging orientation.

In some examples of the method, apparatus, and non-transitory computer-readable medium described herein, the support post may include operations, features, means, or instructions for a removable support post configured to interface with the charging post in either of the first charging orientation or the second charging orientation.

In some examples of the method, apparatus, and non-transitory computer-readable medium described herein, the removable support post may include operations, features, means, or instructions for an outer circumferential surface and a receiving hole extending a width of the support post and overlapping a portion of the outer circumferential surface to create a gap in the outer circumferential surface.

Some examples of the method, apparatus, and non-transitory computer-readable medium described herein may further include operations, features, means, or instructions for receive the charging post via the receiving hole, wherein the first charging component of the charging post may be positioned to align with the outer circumferential surface of the removable support post in either of the first charging orientation or the second charging orientation.

In some examples of the method, apparatus, and non-transitory computer-readable medium described herein, the support post may include operations, features, means, or instructions for one or more indentations configured to interface with one or more clip components of the charging post in either of the first charging orientation or the second charging orientation.

In some examples of the method, apparatus, and non-transitory computer-readable medium described herein, a diameter of the retaining component may be greater than a diameter of the support post.

In some examples of the method, apparatus, and non-transitory computer-readable medium described herein, a size of one or more components of the charging device may be based at least in part on a size of the wearable ring device.

In some examples of the method, apparatus, and non-transitory computer-readable medium described herein, the support post may include operations, features, means, or instructions for one or more indentations on an outer circumferential surface of the support post, the one or more indentations configured to interface with one or more dome-shaped protrusions on an inner circumferential surface of the wearable ring device.

In some examples of the method, apparatus, and non-transitory computer-readable medium described herein, one or more magnetic components configured to attract one or more magnetic components of the wearable ring device.

In some examples of the method, apparatus, and non-transitory computer-readable medium described herein, the one or more external power sources comprise one or more of a cell phone, a laptop, a rechargeable portable battery, or a power outlet.

In some examples of the method, apparatus, and non-transitory computer-readable medium described herein, the power receiving component comprises a Universal Serial Bus Type-C connector.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A charging device, comprising:
a support post configured to receive a wearable ring device, the support post comprising a retaining component configured to retain the wearable ring device onto the support post;
a charging post comprising an outer housing, a power receiving component configured to receive power from one or more external power sources, and a first charging component configured to transfer the power from the power receiving component to the wearable ring device to recharge a rechargeable battery of the wearable ring device, wherein the charging device is configured to:
transition between a first charging orientation and a second charging orientation, wherein the first charging orientation comprises an orientation in which the retaining component is on a same side of the support post as the power receiving component and the second charging orientation comprises an orientation in which the retaining component is on a different side of the support post from the power receiving component.

2. The charging device of claim 1, wherein the charging device further comprises:
a hinge component connecting the support post and the charging post, wherein, to transition between the first charging orientation and the second charging orientation, the hinge component is configured to:
rotate the charging post with respect to the support post.

3. The charging device of claim 2, further comprising:
a second charging component configured to transfer the power from the power receiving component to the wearable ring device to recharge the rechargeable battery of the wearable ring device, wherein the first charging component and the second charging component are located on a first position on a circumferential surface of the charging post and a second position on the circumferential surface of the charging post, respectively.

4. The charging device of claim 3, wherein the first charging component is positioned on an outer circumferential surface of the charging device when the charging device is in the first charging orientation, and wherein the second charging component is positioned on the outer circumferential surface of the charging device when the charging device is in the second charging orientation.

5. The charging device of claim 1, wherein the support post comprises:
a removable support post configured to interface with the charging post in either of the first charging orientation or the second charging orientation.

6. The charging device of claim 5, wherein the removable support post comprises:
an outer circumferential surface and a receiving hole extending a width of the support post and overlapping a portion of the outer circumferential surface to create a gap in the outer circumferential surface.

7. The charging device of claim 6, wherein, to interface with the charging post, the removable support post is configured to receive the charging post via the receiving hole, wherein the first charging component of the charging post is positioned to align with the outer circumferential surface of the removable support post in either of the first charging orientation or the second charging orientation.

8. The charging device of claim 5, wherein the support post further comprises:
one or more indentations configured to interface with one or more clip components of the charging post in either of the first charging orientation or the second charging orientation.

9. The charging device of claim 1, wherein a diameter of the retaining component is greater than a diameter of the support post.

10. The charging device of claim 1, wherein a size of one or more components of the charging device is based at least in part on a size of the wearable ring device.

11. The charging device of claim 1, wherein the support post comprises:
one or more indentations on an outer circumferential surface of the support post, the one or more indentations configured to interface with one or more protrusions on an inner circumferential surface of the wearable ring device.

12. The charging device of claim 1, further comprising:
one or more magnetic components configured to attract one or more magnetic components of the wearable ring device.

13. The charging device of claim 1, wherein the one or more external power sources comprise one or more of a cell phone, a laptop, a rechargeable portable battery, or a power outlet.

14. The charging device of claim 1, wherein the power receiving component comprises a Universal Serial Bus Type-C connector.
